(19) United States
(12) Patent Application Publication
(10) Pub. No.: US 2014/0105259 A1
(43) Pub. Date: Apr. 17, 2014

(54) METHOD OF HANDLING PROACTIVE SOFTWARE TOOLKIT COMMANDS AND 3GPP MODEM EQUIPMENT INCORPORATING THE SAME

(71) Applicant: NVIDIA CORPORATION, Santa Clara, CA (US)

(72) Inventor: Alexander May-Weymann, Batiment (FR)

(73) Assignee: NVIDIA CORPORATION, Santa Clara, CA (US)

(21) Appl. No.: 13/653,593

(22) Filed: Oct. 17, 2012

(51) Int. Cl. H04B 1/38

(52) U.S. Cl. 375/222

(57) ABSTRACT

A modem and a method of handling a proactive software toolkit command. In one embodiment, the modem includes: (1) a digital interface configured to receive from a subscriber information module a proactive software toolkit command the modem is designated by standard to handle and (2) a command processor coupled to the digital interface and configured to prepare information regarding the command for transmission to terminal equipment coupled to the modem.

### TECHNICAL FIELD

This application is directed, in general, to mobile telecommunications devices and, more specifically, to a method of handling proactive software toolkit (STK) commands and 3GPP modem equipment (ME) incorporating the method.

### BACKGROUND

As those skilled in the pertinent art are aware, six telecommunications standard development organizations have joined forces to create the Third Generation Partnership Project (3GPP). The 3GPP in turn has defined standards, called Technical Specifications (TSs), that govern the development of, for example, Universal Mobile Telecommunications System (UMTS), High Speed Packet Access (HSPA), Long Term Evolution (LTE) and Evolved Packet Core (EPC), and therefore act as technology evolution paths for transforming disparate wireless telecommunication standards over time into a single, unified worldwide system for mobile devices, such as smartphones. Consequently, a wide range of powerful mobile telecommunications devices is beginning to appear in the market and gain rapid acceptance.

A 3GPP wireless device contains terminal equipment (TE) in which subscriber-accessible applications (such as smartphone “apps”) are executed, and a mobile station (MS), which provides wireless connectivity. The MS in turn contains a mobile termination (MT), which itself contains a modulation/demodulation circuit (ME or “modem”). The ME allows the MS to communicate over wireless carrier frequencies. While modern ME are sophisticated, they still use so-called “Attention” or “AT” commands, which were employed to control some of the first modems ever developed. 3GPP Technical Specification (TS) 27 defines the AT commands that may be employed to interact with ME via a terminal adapter (TA).

More particularly, 3GPP TS 27.007 (starting at Release 10) also defines AT commands to handle the STK, such as AT+CUSAT . . . . TS 27.007 also specifies a way to decide the equipment that should handle proactive commands, e.g., the TE or the MT. TS 27.007 also specifies STK related “unsolicited indications,” such as “+CUSATP:.”

3GPP wireless devices also contain a memory device called a Subscriber Information Module (SIM), MicroSIM (μSIM) or Universal Integrated Circuit Card (UICC). SIMs, μSIMs and UICCs contain not only subscriber-specific data, such as subscriber identification and device configuration information, but also software programs, called “applets,” which tailor the wireless devices to operate in their respective telecommunications networks and provide value-added services to subscribers. TS 31, particularly 31.102 and 31.111, defines the interface between the SIM, μSIM or UICC and the MS. An STK, also contained in the SIM, μSIM or UICC, provides a software interface by which the applets can communicate with the MT.

More specifically, TS 31.111 defines specific “proactive commands” (actions an applet takes through an STK on its own initiative and not in response to a stimulus by the wireless device/AT-command). TS 31.111 also specify how each of the proactive commands is to be handled.

### SUMMARY

One aspect provides an ME. In one embodiment, the ME includes: (1) a digital interface configured to receive from a SIM a proactive STK command the ME is designated by standard to handle and (2) a command processor coupled to the digital interface and configured to prepare information regarding the command for transmission to TE coupled to the ME.

Another aspect provides a method of handling a proactive STK command. In one embodiment, the method includes: (1) receiving from a SIM a proactive STK command into a ME, (2) determining that the ME is to handle the command, (3) preparing information regarding the proactive command for transmission to TE associated with the ME and (4) queuing the information for transmission.

Yet another aspect provides a MT. In one embodiment, the MT includes: (1) a radio and (2) a 3GPP ME coupled to the radio and including: (2a) a digital interface configured to receive from a SIM a proactive STK command the 3GPP designates the ME to handle and (2b) a command processor coupled to the digital interface and configured to prepare information regarding the proactive command for transmission to TE coupled to the 3GPP ME.

### BRIEF DESCRIPTION

Reference is now made to the following descriptions taken in conjunction with the accompanying drawings, in which:

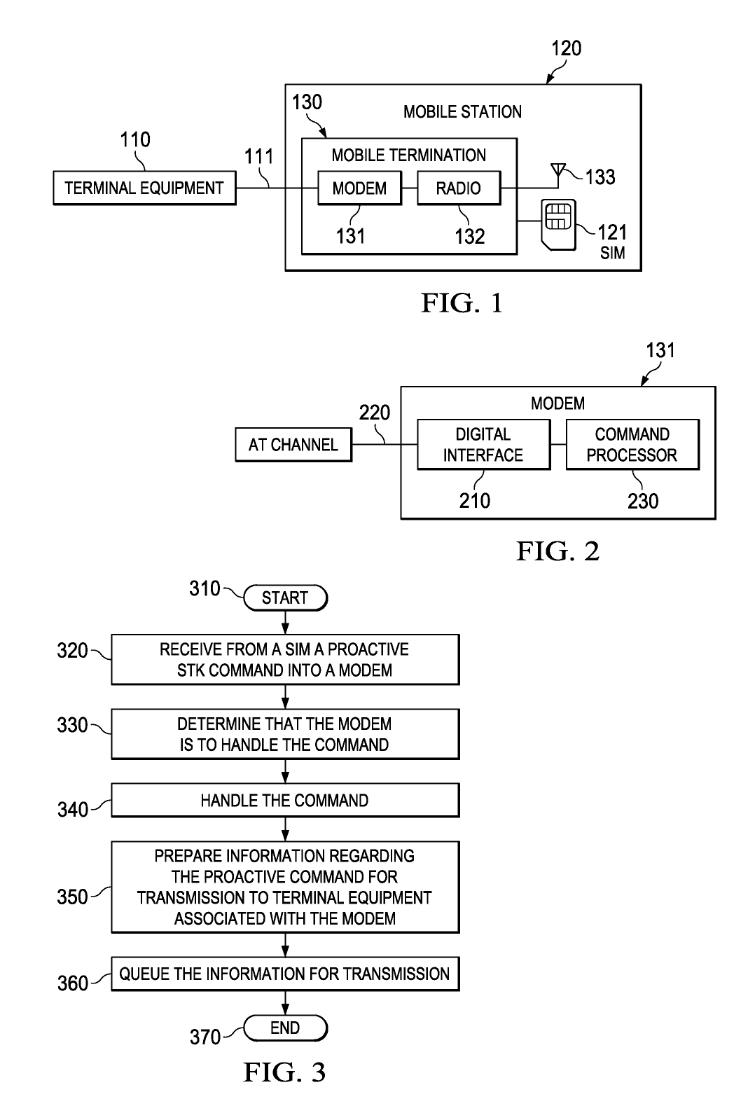

FIG. 1 is a block diagram of terminal equipment (TE) and a mobile station (MS) forming an environment in which the system or method can operate;

FIG. 2 is a block diagram of one embodiment of a modem; and

FIG. 3 is a flow diagram of one embodiment of a method of handling proactive STK commands.

### DETAILED DESCRIPTION

As stated above, Release 10 of TS 27.007 specifies AT commands to configure which proactive STK commands the TE can or must handle and which proactive STK commands the ME can or must handle. However, it is realized herein that this designation by TS 27.007 is exclusive. In other words, TS 27.007 designates either the TE or the ME to handle a particular proactive command, but never both. While this may seem innocuous or even pedantic, it is realized herein that serious disadvantages can occur when the ME is designated to handle a particular command, but the TE would benefit from information regarding the command that the ME is handling. Stated another way, a problem occurs if the ME is designated to handle a proactive command, but the command is such that the TE should also be involved, or at least be informed of the fact that the ME is handling it.

To illustrate, if the ME is to handle a particular proactive command according to TS 27.007, the ME only transmits a response back to the applet through the STK once handling is complete. However, if the proactive command involves the TE, the TE remains uninformed. For example, if the command involves starting a telephone call, the TE never receives information regarding the command that might prompt it to adapt the screen. As another example, the TE would not be prompted to take into account modified SIM files (e.g., containing the phonebook or Short Message Service center functions). As yet another example, the TE is unable to allow the subscriber to interrupt the applet, e.g., via a keyboard.

It is therefore fundamentally realized herein that TS 27.007 fails to cover all use cases, and therefore that the TE would benefit from information regarding proactive commands allocated to the ME for handling.

Introduced herein are various embodiments of a modem in which information regarding a proactive STK command that the modem is handling is provided to the TE. Also introduced herein are various embodiments of a method of handling proactive STK commands according to which information regarding an command being handled by ME is provided to TE. In some embodiments, the information includes text intended for the TE to display.

One embodiment provides a novel unsolicited command in the same general form as “+CUSATP: <proactive_cmd>.” An alternative embodiment employs a special command simply calling for a string to be passed from the ME to the TE and then displayed. In the former embodiment, the novel command may include other useful information for the TE. For example, in the case of a REFRESH, the command may include a list of modified SIM files, which the TE can then employ to update any internally buffered SIM values.

Another embodiment allows the TE to configure the ME to establish the proactive commands (that are handled by the ME) about which the TE should be notified. For example, some proactive commands may be of no use to the TE, or the TE may be incapable of displaying information regarding particular commands. Accordingly, this embodiment allows the TE to register a profile with the ME. In one particular embodiment, the profile is registered similar to the <profile> command from AT+CUSATW.

Having generally described various realizations leading to a novel modem and a method, various embodiments of the novel modem and method will now be described. Accordingly, FIG. 1 is a block diagram of TE 110 and an MS 120 forming an environment in which the system or method can operate.

The TE 110 may also be known as a “host” or “application processor.” The TE 110 is generally configured to provide telecommunications services to a subscriber using the MS 120 and one or more applications, or “apps” that may or may not employ the MS 120 in their operation. A TA 111 couples the TE 110 to the MS 120. The TA may also be known as an AT port. TS 27.007 defines the AT commands that the TE may employ to interact with ME via the TA 111.

The illustrated embodiment of the MS 120 includes an MT 130 and a SIM card 121. Alternative embodiments include a μSIM card and UICC in lieu of the SIM card 121. The MT 130 may also be known as mobile equipment (ME). The MT 130 is generally configured to respond to AT commands to initiate and terminate data connections to effect the communication of data (e.g., voice, video or computer data) over a wireless telecommunications network.

The MT 130 includes a modem 131, also called ME, and a radio 132. The modem 131 is generally configured to transform digital data into symbols that the radio 132 uses to generate a transmission. The modem 131 is also generally configured to transform symbols provided by the radio 132 into digital data for use by the TE 110. The radio 132 is generally configured to modulate a carrier wave with symbols provided by the modem 131 to yield a radio-frequency (RF) signal and transmit the RF signal wirelessly using an antenna 133. The radio 132 is further configured to receive and demodulate an RF signal using the carrier wave to yield symbols for use by the modem 131.

The SIM card 121 is a storage device generally configured to contain data (e.g., subscriber identification and device configuration) data particular to a subscriber and software programs that the TE 110 may employ to carry out various functions. As described above, the software programs stored in the SIM card 121 are generally called “applets” and tailor the MS 120 to operate in its telecommunications network and provide value-added services to the subscriber. TS 31.111 defines the interface between the SIM 121 and the MT 130. An STK (not shown) is stored in the SIM 121 along with the applets. As stated above, the STK provides a software interface by which the applets can communicate with the MT 130.

FIG. 2 is a block diagram of one embodiment of a modem, e.g., the modem 131 of FIG. 1. The modem 131 includes a digital interface 210 and a command processor 230 coupled to the digital interface 210.

In the illustrated embodiment, the digital interface 210 is configured to receive an AT command. In the context of 3GPP, the AT command takes the form of a standard 3GPP AT command, e.g., a +CUSAT . . . AT command. It is assumed for purposes of describing FIG. 2 that the standard 3GPP AT command is such that the modem 131 is designated by standard to handle the command.

In the illustrated embodiment, the command processor 230 is thus configured to handle the proactive STK command from a SIM. As part of handling the proactive command, the command processor 230 is further configured to prepare information regarding the proactive command for transmission to the TE (e.g., the TE 110 of FIG. 1). In the illustrated embodiment, the command processor 230 is still further configured to transmit the information it has prepared regarding the proactive command to the TE, at which point the TE is prompted to take appropriate action.

In the illustrated embodiment, a novel unsolicited command in the same general form as “+CUSATP: <proactive_cmd>” is provided. Further, the novel command includes other useful information, such as a list of modified SIM files.

In the illustrated embodiment, the TE is capable of pre-configuring the ME to establish the proactive commands about which the TE should be notified. Accordingly, TE is capable of registering a profile with the ME. In one particular embodiment, the profile is registered similar to the <profile> command from AT+CUSATW.

FIG. 3 is a flow diagram of one embodiment of a method of handling proactive STK commands. The method begins in a start step 310. In a step 320, a proactive STK command is received from a SIM into an ME. In a step 330, it is determined whether or not the ME is to handle the command. If not, the ME does nothing. If so, in a step 340, the ME handles the command. In a step 350, information regarding the proactive command is prepared for transmission to terminal equipment associated with the ME (assuming the ME has been configured to handle the command). In one embodiment, the preparing includes preparing the information for transmission to the TE based on configuration data contained in the ME. In a step 360, the information is queued for transmission. The method ends in an end step 370.

Having described various embodiments of a novel modem and method, an example will now be given in which a mobile device employs the novel modem to inform TE of proactive commands. When the mobile device is started up, the SIM is not yet activated. The TE configures the MT about the STK actions the TE can perform using the AT+CUSATW (confTE) command. Next, the TE configures the MT about the STK actions the MT shall perform using the AT+CUSATW (confMT) command. Then the ME replies to the TE with the AT+CUSATA=1 command, indicating that the ME is ready to handle commands. Next, the TE activates the SIM with the AT+CFUN=1 command. Then, the MT combines the confTE and the confMT configurations into a single configuration: confComb. Next, the MT informs the SIM about what can be handled using the confComb configuration. The SIM does not need have information regarding which of the possible STK actions will be handled by the TE and which ones by the MT. The SIM simply issues commands, and the commands are handled. At this point, an applet on the SIM can initiate.

Once the applet on the SIM has initiated, proactive STK actions begin. Accordingly, the SIM indicates a pending STK action to the MT. The MT reads the action, analyses it and decides if the action is something to be handled by the TE or the MT (depending on confTE and confMT). Then the TE or MT handles the action and returns a result to the SIM in a reasonable amount of time. If the result is not returned to the SIM in a reasonable amount of time, the STK applet on the SIM can be blocked.

If the TE is to handle a command, the command is indicated as having been received by the SIM using +CUSATP. The TE then decodes the command and takes all actions that are needed to handle the command. On completion, the TE sends to the TM a coded response using AT+CUSATT. The MT then forwards the coded response to the SIM.

If the MT is to handle a command, the MT decodes the command and takes all actions that are needed to handle the command. As part of the handling, the MT prepares information to be transmitted to the TE. The TE receives the information and takes action based on the information as appropriate.

In various embodiments, the TE takes action based on the information in various ways. In one embodiment, the TE causes text to be displayed on the screen of the wireless device. In another embodiment, the TE causes an additional, e.g., provider-specific, submenu to be displayed on the screen of the wireless device. In yet another embodiment, the TE prompts a subscriber to provide a response via a keypad, keyboard or touchscreen of the wireless device. In still another embodiment, the information prompts the TE to update local copies of one or more files stored in the SIM. In yet still another embodiment, the TE causes an event list to be established. In various specific embodiments, the event list includes the mobile device's current location, the subscriber's registration status and the subscriber's preferred language. Other information is included in the event list in alternative embodiments. In still yet another embodiment, the information prompts the TE to cause the SIM to initiate a call on the mobile device. These are only examples. Those skilled in the pertinent art will perceive many more actions that a TE may take given knowledge of the handling by the MT or the ME of a proactive command. All such actions fall within the broad scope of the invention.

Those skilled in the art to which this application relates will appreciate that other and further additions, deletions, substitutions and modifications may be made to the described embodiments.

What is claimed is:

1. A modem, comprising:
a digital interface configured to receive from a subscriber information module a proactive software toolkit command said modem is designated by standard to handle; and
a command processor coupled to said digital interface and configured to prepare information regarding said command for transmission to terminal equipment coupled to said modem.

2. The modem as recited in claim 1 wherein said information includes text for said terminal equipment to display.

3. The modem as recited in claim 1 wherein said command is a 3GPP AT command.

4. The modem as recited in claim 1 wherein said information is associated with one of a complete coded proactive software toolkit command from said subscriber information module and a special AT command containing a string to be displayed.

5. The modem as recited in claim 1 wherein said command processor is further configured to prepare said information for transmission to said terminal equipment based on configuration data contained in said modem.

6. The modem as recited in claim 1 wherein said command is selected from the group consisting of:
display text,
set up menu,
get input,
refresh,
set up event list, and
set up call.

7. The modem as recited in claim 1 wherein said modem is a 3GPP modem.

8. A method of handling a proactive software toolkit command, comprising:
receiving from a subscriber information module a proactive software toolkit command into a modem;
determining that said modem is to handle said command;
preparing information regarding said command for transmission to terminal equipment associated with said modem; and
queuing said information for transmission.

9. The method as recited in claim 8 wherein said information includes text for said terminal equipment to display.

10. The method as recited in claim 8 wherein said command is a 3GPP AT command.

11. The method as recited in claim 8 wherein said information is associated with one of a complete coded proactive software toolkit command from said subscriber information module and a special AT command containing a string to be displayed.

12. The method as recited in claim 8 wherein said preparing comprises preparing said information for transmission to said terminal equipment based on configuration data contained in said modem.

13. The method as recited in claim 8 wherein said command is selected from the group consisting of:
display text,
set up menu,
get input,
refresh,
set up event list, and
set up call.

14. The method as recited in claim 8 wherein said modem is a 3GPP modem.

15. A mobile termination, comprising:
a radio; and
a 3GPP modem coupled to said radio and including:
a digital interface configured to receive from a subscriber information module a proactive software toolkit command the 3GPP standard designates said modem to handle, and
a command processor coupled to said digital interface and configured to prepare information regarding said command for transmission to terminal equipment coupled to said 3GPP modem.

16. The mobile termination as recited in claim 15 wherein said information includes text for said terminal equipment to display.

17. The mobile termination as recited in claim 15 wherein said command is a 3GPP AT command.

18. The mobile termination as recited in claim 15 wherein said information is associated with one of a complete coded proactive software toolkit command from said subscriber information module and a special AT command containing a string to be displayed.

19. The mobile termination as recited in claim 15 wherein said command processor is further configured to prepare said information for transmission to said terminal equipment based on configuration data contained in said 3GPP modem.

20. The mobile termination as recited in claim 15 wherein said command is selected from the group consisting of:
display text,
set up menu,
get input,
refresh,
set up event list, and
set up call.
